(19) United States
(12) Patent Application Publication
(10) Pub. No.: US 2026/0362289 A1
(43) Pub. Date: Nov. 12, 2026

(54) TIMER INFORMATION PROCESSING METHOD AND APPARATUS, AND RELATED DEVICE

(71) Applicant: VIVO MOBILE COMMUNICATION CO., LTD., Dongguan (CN)

(72) Inventor: Jinhua LIU, Dongguan (CN)

(73) Assignee: VIVO MOBILE COMMUNICATION CO., LTD., Dongguan, GD (CN)

(21) Appl. No.: 19/722,474

(22) Filed: Jun. 26, 2026

Related U.S. Application Data
(63) Continuation of application No. PCT/CN2024/141273, filed on Dec. 23, 2024.

(30) Foreign Application Priority Data
Dec. 29, 2023 (CN) 202311861606.X

(51) Int. Cl. H04W 40/22; H04W 40/24; H04W 88/04

(52) U.S. Cl. CPC H04W 40/22; H04W 40/248; H04W 88/04

(57) ABSTRACT

This application discloses a timer information processing method and apparatus, and a related device, and belongs to the field of communication technologies. The timer information processing method in embodiments of this application includes: a remote user equipment (UE) obtaining initial value configuration parameters of a timer and hop count information, where the hop count information is used for determining a first hop count, the first hop count is a backhaul hop count of a backhaul link in a relay network, and the initial value configuration parameters are related to the backhaul hop count of the backhaul link; and the remote UE determining an initial value of the timer based on the initial value configuration parameters and the first hop count, where the initial value is used for determining running duration of the timer.

### CROSS-REFERENCE TO RELATED APPLICATIONS

This application is a continuation application of International Application No. PCT/CN2024/141273, filed on Dec. 23, 2024, which claims priority to Chinese Patent Application No. 202311861606.X, filed in China on Dec. 29, 2023, which is incorporated herein by reference in its entirety.

### TECHNICAL FIELD

This application belongs to the field of communication technologies, and specifically, to a timer information processing method and apparatus, and a related device.

### BACKGROUND

In a multi-hop Layer 2 (L2) relay network (a multi-hop relay network for short), a signaling and data transmission delay between remote user equipment (UE) and a serving base station depends on a hop count of a data backhaul path. A larger hop count indicates a longer transmission delay. Running time of some timers directly or indirectly covers time required for uplink/downlink signaling transmission of a corresponding program procedure.

### SUMMARY

According to a first aspect, a timer information processing method is provided, including:
a remote user equipment (UE) obtaining initial value configuration parameters of a timer and hop count information, where the hop count information is used for determining a first hop count, the first hop count is a backhaul hop count of a backhaul link in a relay network, and the initial value configuration parameters are related to the backhaul hop count of the backhaul link; and
the remote UE determining an initial value of the timer based on the initial value configuration parameters and the first hop count, where the initial value is used for determining running duration of the timer.

According to a second aspect, a timer information processing method is provided, including:
a network side device sending initial value configuration parameters of a timer, where the initial value configuration parameters are related to a hop count of a backhaul link in a relay network.

According to a third aspect, a timer information processing method is provided, including:
a relay UE sending hop count information, where the hop count information is used by a remote UE to determine a first hop count, and the first hop count is a backhaul hop count of a backhaul link in a relay network.

According to a fourth aspect, a timer information processing apparatus is provided, including:
a first obtaining module, configured to obtain initial value configuration parameters of a timer and hop count information, where the hop count information is used for determining a first hop count, the first hop count is a backhaul hop count of a backhaul link in a relay network, and the initial value configuration parameters are related to the backhaul hop count of the backhaul link; and
a first determining module, configured to determine an initial value of the timer based on the initial value configuration parameters and the first hop count, where the initial value is used for determining running duration of the timer.

According to a fifth aspect, a timer information processing apparatus is provided, including:
a first sending module, configured to send initial value configuration parameters of a timer, where the initial value configuration parameters are related to a hop count of a backhaul link in a relay network.

According to a sixth aspect, a timer information processing apparatus is provided, including:
a second sending module, configured to send hop count information, where the hop count information is used by a remote UE to determine a first hop count, and the first hop count is a backhaul hop count of a backhaul link in a relay network.

According to a seventh aspect, a terminal is provided. The terminal includes a processor and a memory. The memory stores a program or instructions runnable on the processor, and the program or the instructions, when executed by the processor, implement steps of the method according to the first aspect or the third aspect.

According to an eighth aspect, a terminal is provided, including a processor and a communication interface. The communication interface is configured to obtain initial value configuration parameters of a timer and hop count information, where the hop count information is used for determining a first hop count, the first hop count is a backhaul hop count of a backhaul link in a relay network, and the initial value configuration parameters are related to the backhaul hop count of the backhaul link. The processor is configured to determine an initial value of the timer based on the initial value configuration parameters and the first hop count, where the initial value is used for determining running duration of the timer. Alternatively, the communications interface is configured to send hop count information, where the hop count information is used by a remote UE to determine a first hop count, and the first hop count is a backhaul hop count of a backhaul link in a relay network.

According to a ninth aspect, a network side device is provided. The network side device includes a processor and a memory. The memory stores a program or instructions runnable on the processor, and the program or the instructions, when executed by the processor, implement steps of the method according to the second aspect.

According to a tenth aspect, a network side device is provided, including a processor and a communication interface, where the communication interface is configured to send initial value configuration parameters of a timer, and the initial value configuration parameters are related to a hop count of a backhaul link in a relay network.

According to an eleventh aspect, a readable storage medium is provided. The readable storage medium stores a program or instructions, and the program or instructions, when executed by a processor, implement the steps of the method according to the first aspect, or implement the steps of the method according to the second aspect, or implement the steps of the method according to the third aspect.

According to a twelfth aspect, a timer information processing system is provided, including: remote UE, relay UE, and a network side device, where the remote UE is configured to perform steps of the method according to the first aspect, the network side device is configured to perform steps of the method according to the second aspect, and the relay UE is configured to perform steps of the method according to the third aspect.

According to a thirteenth aspect, a chip is provided. The chip includes a processor and a communication interface, where the communication interface is coupled to the processor, and the processor is configured to run a program or instructions to implement the method according to the first aspect, or implement the method according to the second aspect, or implement the method according to the third aspect.

According to a fourteenth aspect, a computer program/program product is provided. The computer program/program product is stored in a storage medium, and the computer program/program product is executed by at least one processor to implement steps of the method according to the first aspect, the second aspect, or the third aspect.

### BRIEF DESCRIPTION OF THE DRAWINGS

FIG. 1 is a first diagram of a relay scenario to which embodiments of this application are applicable.

FIG. 2 is a diagram of a user plane protocol stack of Layer 2 U2N relay.

FIG. 3 is a diagram of a control plane protocol stack of a Layer 2 U2N relay.

FIG. 4 is a second diagram of a relay scenario to which embodiments of this application are applicable.

FIG. 5 is a diagram of a relationship between relay user equipment in a relay network.

FIG. 6 is a first schematic flowchart of a timer information processing method according to an embodiment of this application.

FIG. 7 is a second schematic flowchart of a timer information processing method according to an embodiment of this application.

FIG. 8 is a third schematic flowchart of a timer information processing method according to an embodiment of this application.

FIG. 9 is a first diagram of modules of a timer information processing apparatus according to an embodiment of this application.

FIG. 10 is a second diagram of modules of a timer information processing apparatus according to an embodiment of this application.

FIG. 11 is a third diagram of modules of a timer information processing apparatus according to an embodiment of this application.

FIG. 12 is a structural block diagram of a communication device according to an embodiment of this application.

FIG. 13 is a structural block diagram of a terminal according to an embodiment of this application.

FIG. 14 is a structural block diagram of a network side device according to an embodiment of this application.

### DETAILED DESCRIPTION

The following clearly describes the technical solutions in the embodiments of this application with reference to the accompanying drawings in the embodiments of this application. Apparently, the described embodiments are some of the embodiments of this application rather than all of the embodiments. All other embodiments obtained by a person of ordinary skill in the art based on the embodiments of this application shall fall within the scope of protection of this application.

In this application, the terms “first”, “second”, and the like are used to distinguish between similar objects but are not used to describe a specific order or sequence. It should be understood that, the terms used in this way are interchangeable in a proper case, so that the embodiments of this application can be implemented in orders other than those illustrated or described herein. In addition, objects distinguished by “first” and “second” are typically of a same type, and a quantity of objects is not limited. For example, one or more first objects may be provided. In addition, “or” in this application indicates at least one of connected objects. For example, “A or B” covers three solutions, that is, solution 1: including A and excluding B; solution two: including B and excluding A; and solution 3: including both A and B. The character “/” generally indicates an “or” relationship between associated objects.

The term “indication” in this application may be a direct indication (or an explicit indication), or may be an indirect indication (or an implicit indication). The direct indication may be understood as that a sender explicitly notifies a receiver of content such as specific information, an operation that needs to be performed, or a request result in a sent indication. The indirect indication may be understood as that the receiver determines corresponding information based on the indication sent by the sender, or performs determining and determines an operation that needs to be performed or a request result based on a determining result.

It should be noted that the technology described in the embodiments of this application is not limited to a long term evolution (LTE)/LTE-advanced (LTE-A) system, and is further applicable to another wireless communication system, such as code division multiple access (CDMA), time division multiple access (TDMA), frequency division multiple access (FDMA), orthogonal frequency division multiple access (OFDMA), single-carrier frequency-division multiple access (SC-FDMA), or another system. The terms “system” and “network” in the embodiments of this application are usually used interchangeably. The described technologies are applicable to the systems and radio technologies mentioned above, and are also applicable to other systems and radio technologies. The following description describes a new radio (NR) system for exemplary purposes, and NR terms are used in most of the following description. However, the technologies are also applicable to a system other than the NR system, such as a 6^{th} generation (6G) communication system.

FIG. 1 shows a single-hop L2 user equipment-to-network (UE-to-Network, U2N) relay scenario. In this scenario, remote user equipment (UE) 11 is connected to a network side device 13 via relay UE 12. A sidelink refers to a radio link between a UE and a UE in NR/LTE. Two UEs may implement direct data transmission between the two UEs via the sidelink. A radio link between sidelinks is also referred to as a PC5 link that runs the PC5 protocol. In the related technology, research is conducted on using a UE to provide a relay service between a UE and a network. The UE providing a relay service is referred to as a relay UE, the UE provided with an ultimate service is referred to as a remote UE, the link between the relay UE and the remote UE is a PC5 link that runs the sidelink interface protocol, a link between the relay UE and a base station is a Uu link that runs the Uu link protocol.

A control plane of a sidelink radio interface includes a PC5 Radio Resource Control (RRC) protocol that runs above a Packet Data Convergence Protocol (PDCP) layer and a Radio Link Control (RLC) layer, with a Medium Access Control (MAC) layer and a physical layer at the bottom. A user plane of the sidelink radio interface includes, from top to bottom, a Service Data Adaptation Protocol (SDAP), a PDCP, an RLC, an MAC, and a physical layer (Physical, PHY).

A sidelink U2N relay includes an L2U2N relay and a Layer 3 (L3) relay. The L2U2N relay refers to the relay UE forwarding data of the remote UE at layer 2, and the L3 relay refers to the relay UE forwarding data of the remote UE at layer 3.

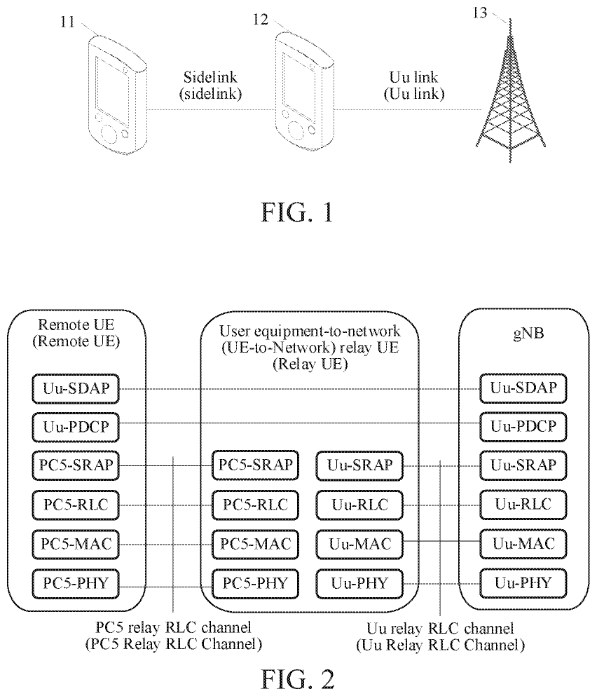

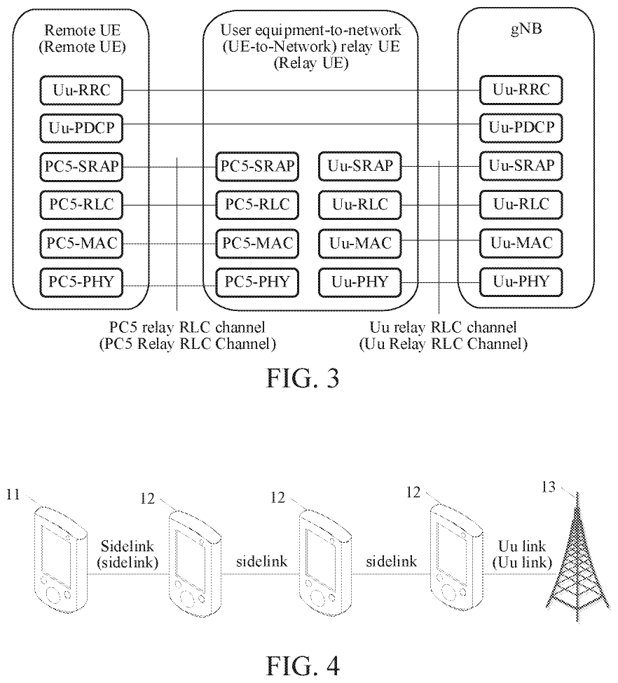

For a user plane protocol stack and a control plane protocol stack of the Layer 2 U2N relay, refer to FIG. 2 and FIG. 3. The L2 U2N relay introduces a sidelink relay adaptation protocol (SRAP) layer used for data routing. The layer carries local UE identification (local UE ID) of the remote UE and radio bearer identification information between the remote UE and the base station. Based on this information, the relay UE performs mapping of the forwarded data from an input logical channel to an output logical channel. For an uplink protocol data unit (PDU) that is forwarded to the base station via the relay UE, the remote UE adds an SRAP header to the PDU, to generate an SRAP PDU. After receiving the SRAP PDU, the relay UE forwards the SRAP PDU based on the SRAP header. After receiving the SRAP PDU, the base station determines a corresponding PDCP entity based on information carried in the SRAP, and submits a corresponding service data unit (SDU) to the PDCP entity after removing the SRAP header. For a downlink PDU that is forwarded to the remote UE via the relay UE, the base station adds an SRAP header to the PDU, to generate an SRAP PDU. After receiving the SRAP PDU, the relay UE forwards the SRAP PDU based on the SRAP header. After receiving the SRAP PDU, the remote UE determines a corresponding PDCP entity based on information carried in the SRAP, and submits a corresponding SDU to the PDCP entity after removing the SRAP header.

For an L3 U2N relay, data is forwarded at an Internet Protocol (IP) layer, and a protocol layer of a Radio Access Network (RAN) is not correspondingly improved. Details are not described herein again.

FIG. 4 shows a multi-hop L2 UE-to-network (U2N) relay scenario. In this scenario, remote UE 11 is connected to a network side device 13 via a plurality of cascaded relay UEs 12. That is, uplink/downlink message of a remote UE need to be relayed via a plurality of L2 U2N relay UEs in a hop-by-hop manner to complete transmission between the remote UE and a base station. The remote UE may alternatively be described as a U2N remote UE, and the relay UE 12 may alternatively be described as a U2N relay.

In a multi-hop L2 U2N network, an adaptation layer is still present to guide data forwarding and enable end-to-end packet identification. A header format and a routing mechanism of the adaptation layer may be obtained by performing necessary modifications on a header format and a routing mechanism of an adaptation layer in a single-hop L2 U2N network, to meet routing requirements of the multi-hop network.

The remote UE or the relay UE may be referred to as a terminal device or a user terminal (User Equipment, UE), which may be a terminal side device such as a mobile phone, a tablet personal computer, a laptop computer, a notebook computer, a personal digital assistant (PDA), a palmtop computer, a netbook, an ultra-mobile personal computer (UMPC), a mobile Internet device (MID), an augmented reality (AR) device, a virtual reality (VR) device, a robot, a wearable device, a flight vehicle, a vehicle user equipment (VUE), a ship user equipment, a pedestrian user equipment (PUE), a smart household (a household device having a wireless communication function, such as a refrigerator, a television, a washing machine, or furniture), a game console, a personal computer (PC), a teller machine, or a self-service machine. The wearable device includes: a smartwatch, a smart wristband, a smart earphone, smart glasses, smart jewelry (a smart bracelet, a smart bangle, a smart ring, a smart necklace, a smart ankle bracelet, a smart anklet, and the like), a smart wrist strap, smart clothing, and the like. The vehicle user equipment may alternatively be referred to as an in-vehicle terminal, an in-vehicle controller, an in-vehicle module, an in-vehicle component, an in-vehicle chip, an in-vehicle unit, or the like. It should be noted that a specific type of the terminal 11 is not limited in the embodiments of this application. The network side device 12 may include an access network device or a core network device. The access network device may alternatively be referred to as a radio access network (RAN) device, a radio access network function, or a radio access network unit. The access network device may include a base station, a wireless local area network (WLAN) access point (AP), a wireless fidelity (WiFi) node, or the like. The base station may be referred to as a node B (NB), an evolved node B (eNB), the next generation node B (gNB), a new radio node B (NR Node B), an access point, a relay base station (RBS), a serving base station (SBS), a base transceiver station (BTS), a radio base station, a radio transceiver, a basic service set (BSS), an extended service set (ESS), a home node B (HNB), a home evolved node B, a transmission reception point (TRP), or anther suitable term in the art. As long as the base station achieves the same technical effect, the base station is not limited to a specific technical term. It should be noted that a description is made by using the base station in the NR system only as an example in the embodiments of this application, and a specific type of the base station is not limited.

In addition, terms in the multi-hop relay network are defined as follows in the embodiments of this application:

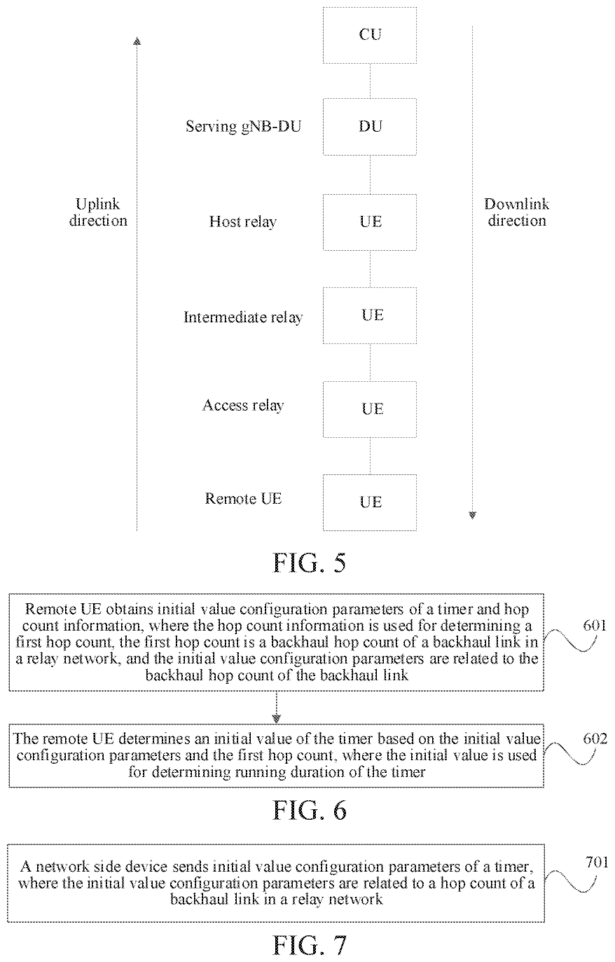

For ease of description, in this application, the multi-hop L2 U2N relay network is referred to as a multi-hop relay network for short. Relative to the remote UE in FIG. 5, relays in the multi-hop L2 U2N relay network are classified and defined as follows:

Host relay: it establishes a Uu connection with a serving base station or may establish a Uu connection with the serving base station, and assists a downstream UE in forwarding data and signaling to the base station and forwards data and signaling from the base station to the downstream UE.

Access relay: it establishes a PC5 connection with a remote UE, assists the remote UE in forwarding uplink/downlink data and signaling forward, and serves as an access relay for the remote UE.

Intermediate relay: it is a relay UE intervening between the access relay and the host relay, and assists the remote UE in forwarding data and signaling between the access relay and the host relay. In the multi-hop relay network, 0, 1, or more intermediate relays may exist between an access relay and a host relay of one remote UE.

Downstream UE: all UEs that access a network via a same relay UE are downstream UEs of the relay UE.

Upstream UE: a relay UE that forwards uplink/downlink data and singling for a same UE is an upstream UE of the UE.

Child UE and parent UE: if a relay UE a establishes a PC5 connection with an upstream relay UE b to access a network, the relay UE b is a parent UE of the UE a, and the relay UE a is a child UE of the UE b.

In FIG. 5, the access relay also has the identity of a remote UE relative to the intermediate relay. The intermediate relay also has the identity of a remote UE relative to the host relay, and so on. Details are not described subsequently in this application.

In the subsequent description of this application, the single-hop L2 U2N relay network is referred to as a single-hop relay network. In the single-hop relay network, a quantity of hops between a remote UE and a serving base station is fixed to 2 hops (one-hop PC5 link (link)+one-hop Uu link), and a quantity of hops experienced by uplink/downlink signaling and data transmission is fixed. In the multi-hop L2 relay network (the multi-hop relay network for short), a signaling and data transmission delay between a remote UE and a serving base station depend on a hop count of a data backhaul path. A total hop count ranges from 2 to N (N denotes a maximum hop count allowed by a network and may be a limited or infinite value). A larger hop count indicates a longer transmission delay.

Because time required by a transmission delay of uplink/downlink signaling in the multi-hop relay network largely depends on the quantity of hops between the remote UE and the serving base station, transmission time required by the multi-hop relay network to complete a signaling procedure may be longer than running time of a timer. Based on running duration of the existing timer, the multi-hop relay network fails to complete corresponding signaling transmission during running of the timer, which consequently triggers an unnecessary timer expiration event.

Embodiments of this application provide a timer information processing method and apparatus, and a related device, to solve a problem that, based on running duration of the existing timer, a multi-hop relay network fails to complete corresponding signaling transmission during running of the timer, which consequently triggers an unnecessary timer expiration event.

The following describes a timer information processing method provided in the embodiments of this application in detail by using some embodiments and application scenarios of the timer information processing method with reference to the accompanying drawings.

As shown in FIG. 6, an embodiment of this application provides a timer information processing method, including:

Step 601: Remote UE obtains initial value configuration parameters of a timer and hop count information, where the hop count information is used for determining a first hop count, the first hop count is a backhaul hop count of a backhaul link in a relay network, and the initial value configuration parameters are related to the backhaul hop count of the backhaul link.

Optionally, the relay network is a multi-hop relay network.

Optionally, the first hop count includes a total hop count of the backhaul link in the relay network or a PC5 link-based hop count of the backhaul link.

Optionally, the backhaul link is a backhaul link between the remote UE and a network side device in the relay network.

In this embodiment of this application, after obtaining the hop count information, the remote UE determines the first hop count based on the hop count information.

In this embodiment of this application, the initial value configuration parameters may be obtained from the network side device based on a system message or an RRC message. For example, a relay UE within the coverage of a signal of a base station receives the system message including the initial value configuration parameters from the base station, and forwards the system message to a downstream relay UE and a remote UE. After receiving the system message from an upstream relay UE, one relay UE forwards the system message to the downstream relay UE and the remote UE.

Step 602: The remote UE determines an initial value of the timer based on the initial value configuration parameters and the first hop count, the initial value being used for determining running duration of the timer.

In an implementation, the initial value is the running duration of the timer.

Optionally, the timer is a timer in the related technology, or may be a newly defined timer.

In this embodiment of this application, the remote UE determines the initial value of the timer based on the initial value configuration parameters related to the backhaul hop count of the backhaul link and the backhaul hop count of the backhaul link in the relay network. In this way, an objective of determining the running duration of the timer based on the backhaul hop count of the backhaul link is achieved, such that the running duration of the timer matches transmission time required by a signaling procedure corresponding to the timer in the relay network. As a result, an unnecessary timer expiration event caused by the remote UE failing to complete corresponding signaling transmission during running of the timer due to improperly configured running duration of the timer can be avoided or reduced, thereby effectively reducing a link interruption count and power consumption of a terminal, and improving wireless connection management performance.

Optionally, that the remote UE determines the initial value of the timer based on the initial value configuration parameters and the first hop count includes:
the remote UE determines a second hop count based on the first hop count, where the second hop count is a hop count associated with the initial value of the timer; and
the remote UE determines the initial value of the timer based on the second hop count and the initial value configuration parameters.

Herein, the remote UE determines, based on the obtained first hop count, the second hop count related to the initial value of the timer, and then determines the initial value of the timer based on the second hop count and the initial value configuration parameters. In this way, the running duration of the timer matches the transmission time of the signaling procedure corresponding to the timer in the relay network, to avoid triggering an unnecessary timer expiration event.

Optionally, that the remote UE determines the second hop count based on the first hop count includes at least one of the following items:
a first item: determining the first hop count as the second hop count in a case that the first hop count is a total backhaul hop count of the backhaul link between the remote UE and the network side device in the relay network;
a second item: determining the second hop count based on the PC5 connection-based hop count of the backhaul link in a case that the first hop count is the total backhaul hop count of the backhaul link between the remote UE and the network side device in the relay network;
a third item: determining the second hop count based on the first hop count and a first adjustment value in a case that the first hop count is the total backhaul hop count of the backhaul link between the remote UE and the network side device in the relay network;
a fourth item: determining the first hop count as the second hop count in a case that the first hop count is a PC5 connection-based backhaul hop count of the backhaul link between the remote UE and the network side device in the relay network;
a fifth item: determining the second hop count based on the first hop count and a second adjustment value in a case that the first hop count is the PC5 connection-based backhaul hop count of the backhaul link between the remote UE and the network side device in the relay network; and
a sixth item: determining the first hop count as the second hop count in a case that the first hop count is equal to the PC5 connection-based backhaul hop count of the backhaul link between the remote UE and the network side device in the relay network minus a third adjustment value.

The first adjustment value, the second adjustment value, and the third adjustment value are all pre-configured integers, and the first adjustment value, the second adjustment value, and the third adjustment value may be the same or may be different.

In an implementation, the first adjustment value, the second adjustment value, and the third adjustment value are all 1.

For the first item, the total backhaul hop count of the backhaul link between the remote UE and the network side device in the relay network is determined as the second hop count, and subsequently, the initial value of the timer may be determined based on a delay increment corresponding to each hop in the second hop count. It is assumed that the second hop count is N, the delay increment corresponding to each hop in the second hop count is Δ, and the initial value of the timer is T0,

$$T 0 = {\sum }_{i = 1}^{i = N} Δ .$$

In this way, it is ensured that the running duration of the timer can match the transmission time of the signaling process corresponding to the timer in the entire relay network. 1≤i≤N, and i is a positive integer.

For the second item, the PC5 connection-based hop count of the backhaul link is a value obtained by subtracting 1 from the total hop count, that is, the PC5 connection-based hop count of the backhaul link is determined as the second hop count, and subsequently, the initial value of the timer may be determined based on running duration of the timer when the backhaul link between the remote UE and the network side device includes an one-hop Uu link, the second hop count, and the delay increment corresponding to each hop in the second hop count in the initial value configuration parameters. It is assumed that the second hop count is N, the delay increment corresponding to each hop is Δ, running duration corresponding to a previous one-hop Uu link is X, and the initial value of the timer is T0,

$$T 0 = X + {\sum }_{i = 1}^{i = N} Δ .$$

In this way, it is ensured that the running duration of the timer can match the transmission time of the signaling process corresponding to the timer in the entire relay network. 1≤i≤N, and i is a positive integer.

For the third item, the determining the second hop count based on the first hop count and the first adjustment value may include using a value obtained by subtracting the first adjustment value from the first hop count as the second hop count. For example, the first adjustment value is 1. In this case, the initial value of the timer may be determined based on the running duration (the running duration may alternatively be described as running duration of the timer in a non-relay network) of the timer when the backhaul link between the remote UE and the network side device includes a one-hop Uu link, the second hop count, and the delay increment corresponding to each hop in the second hop count in the initial value configuration parameters. It is assumed that the second hop count is N, the delay increment corresponding to each hop is Δ, the running duration corresponding to the previous one-hop Uu link is X, and the initial value of the timer is T0,

$$T 0 = X + {\sum }_{i = 1}^{i = N} Δ .$$

In this way, it is ensured that the running duration of the timer can match the transmission time of the signaling process corresponding to the timer in the entire relay network. 1≤i≤N, and i is a positive integer.

For the fourth item, the PC5 connection-based backhaul hop count of the backhaul link is determined as the second hop count, and subsequently, the initial value of the timer may be determined based on the running duration of the timer when the backhaul link between the remote UE and the network side device includes a one-hop Uu link, the second hop count, and the delay increment corresponding to each hop in the second hop count in the initial value configuration parameters. It is assumed that the second hop count is N, the delay increment corresponding to each hop is Δ, the running duration corresponding to the previous one-hop Uu link is X, and the initial value of the timer is T0,

$$T 0 = X + {\sum }_{i = 1}^{i = N} Δ .$$

In this way, it is ensured that the running duration of the timer can match the transmission time of the signaling process corresponding to the timer in the entire relay network. 1≤i≤N, and i is a positive integer.

For the fifth item, the determining the second hop count based on the PC5 connection-based backhaul hop count and the second adjustment value may include: using a value obtained by subtracting the second adjustment value from the PC5 connection-based backhaul hop count as the second hop count. For example, the second adjustment value is 1. In this case, the initial value of the timer may be determined based on running duration of the timer in a single-hop relay network, the second hop count, and the delay increment corresponding to each hop in the second hop count. It is assumed that the second hop count is N, the delay increment corresponding to each hop is Δ, the running duration of the timer in the single-hop relay network is Y, and the initial value of the timer is T0,

$$T 0 = Y + {\sum }_{i = 1}^{i = N} Δ .$$

In this way, it is ensured that the running duration of the timer can match the transmission time of the signaling process corresponding to the timer in the entire relay network. 1≤i≤N, and i is a positive integer.

For the sixth item, a value obtained by subtracting the third adjustment value from the PC5 connection-based backhaul hop count of the backhaul link is used as the second hop count. For example, a value obtained by subtracting 1 from the PC5 connection-based backhaul hop count of the backhaul link is used as the second hop count. In this case, the initial value of the timer may be determined based on the running duration of the timer in the single-hop relay network, the second hop count, and the delay increment corresponding to each hop in the second hop count. It is assumed that the second hop count is N, the delay increment corresponding to each hop is Δ, the running duration of the timer in the single-hop relay network is Y, and the initial value of the timer is T0,

$$T 0 = Y + {\sum }_{i = 1}^{i = N} Δ .$$

In this way, it is ensured that the running duration of the timer can match the transmission time of the signaling process corresponding to the timer in the entire relay network. 1≤i≤N, and i is a positive integer.

In this embodiment of this application, the second hop count related to the initial value of the timer is determined based on the first hop count indicated by the hop count information, and the initial value of the timer is determined in different manners for different second hop counts, to ensure that the running duration of the timer can match the transmission time of the signaling procedure corresponding to the timer in the entire relay network.

In an implementation, the initial value configuration parameters include a first initial value. The first initial value is running duration of the timer when the backhaul link between the remote UE and the network side device includes a one-hop Uu link or includes a one-hop Uu link and a one-hop PC5 link.

Optionally, that the remote UE determines the initial value of the timer based on the second hop count and the initial value configuration parameters includes:
determining an adjustment value corresponding to the initial value of the timer based on the second hop count and the delay increment corresponding to each hop in the second hop count; and
determining the initial value of the timer based on the initial value configuration parameters and the adjustment value.

For example, the adjustment value is obtained based on a sum of the delay increments corresponding to each hop in the second hop count. For example, the initial value of the timer is obtained based on a sum of a first initial value and the adjustment value.

It should be noted that the delay increments corresponding to different hops in the second hop count are the same or different. The delay increment corresponding to each hop is determined based on duration required for signaling transmission or processing.

In an implementation, the initial value configuration parameters include an association relationship between the hop count of the backhaul link and a timer initial value.

Optionally, the backhaul hop count of the backhaul link in the association relationship includes at least one of the following:
the first hop count, such as the total backhaul hop count (including a Uu connection-based hop count and a PC5 connection-based hop count) of the backhaul link between the remote UE and the network side device in the relay network, the PC5 connection-based backhaul hop count of the backhaul link between the remote UE and the network side device in the relay network, or a hop count obtained by subtracting 1 from the PC5 connection-based backhaul hop count; and
the second hop count, such as the total backhaul hop count (including the Uu connection-based hop count and the PC5 connection-based hop count) of the backhaul link between the remote UE and the network side device in the relay network, the PC5 connection-based backhaul hop count of the backhaul link between the remote UE and the network side device in the relay network, or the hop count obtained by subtracting 1 from the PC5 connection-based backhaul hop count.

Optionally, the association relationship includes a correspondence between the backhaul hop count of the backhaul link and a timer initial value. For example, in the association relationship, the backhaul hop count is in a one-to-one correspondence with the timer initial value, or a plurality of backhaul hop counts in the association relationship correspond to a same timer initial value.

Alternatively, the association relationship includes a correspondence between a hop count range of the backhaul link and the timer initial value.

For example, a first hop count range corresponds to an initial value of 1, and the first hop count range includes one hop and two hops. A second hop count range corresponds to an initial value of 2, and the second hop count range includes three hops and four hops. A third hop count range corresponds to an initial value of 3, and the third hop count range includes five or more hops.

Optionally, that the remote UE determines the initial value of the timer based on the initial value configuration parameters and the second hop count includes:
the remote UE obtains, based on the association relationship, a timer initial value corresponding to the second hop count; and
determines the timer initial value corresponding to the second hop count as the initial value of the timer.

In this embodiment of this application, for the timer whose corresponding association relationship is configured by the network, when starting the timer, the remote UE searches for the corresponding timer initial value based on the second hop count, and determines the running duration of the timer based on the timer initial value.

It should be noted that in this embodiment of this application, each timer may correspond to an association relationship, or a plurality of timers may correspond to a same association relationship.

Optionally, the method according to this embodiment of this application further includes:
determining, in a case that the first hop count indicates that a PC5 link-based hop count in the relay network is 1, the initial value of the timer based on configured running duration of the timer in the single-hop relay network.

Herein, in a case that the first hop count indicates that the PC5 link-based hop count in the relay network is 1, the running duration of the timer in the single-hop relay network that is configured by the network is determined as the initial value of the timer.

Optionally, that the remote UE obtains the hop count information includes:
the remote UE obtains the hop count information sent by the network side device or relay UE. Optionally, the relay UE includes a host relay or an access relay.

Alternatively, the remote UE obtains the hop count information from an SRAP header of a protocol data unit (PDU) of the sidelink relay adaptation protocol (SRAP). Optionally, the SRAP header includes information about a quantity of hops experienced by data or signaling.

In an implementation, that the remote UE obtains the hop count information includes:

the remote UE obtains the hop count information through a system message, a Uu radio resource control (RRC) message, a PC5 RRC message, a discovery message, or a proximity services (Prose S) message.

Optionally, the method according to this embodiment of this application further includes:
performing a first operation in a case that the remote UE repeatedly transmits, via a plurality of backhaul links, signaling corresponding to the timer.

The first operation includes one of the following items.
A1: Separately start one timer corresponding to the backhaul link after the signaling is sent on each backhaul link, and perform, in a case that the timers corresponding to all the backhaul links expire, an action triggered upon expiry of the timers.

In this term, each backhaul link corresponds to one independent timer. Because the time for the remote UE to perform repeated transmissions of the same signaling on different backhaul links varies, using separate timers facilitates the UE to manage the signaling transmission time for each backhaul link individually.
A2: Start a timer corresponding to the plurality of backhaul links after the signaling is sent on each backhaul link and if the timer corresponding to the plurality of backhaul links is not running; or restart the timer corresponding to the plurality of backhaul links if the timer corresponding to the plurality of backhaul links is running, where the initial value of the timer is determined based on the first hop count or the second hop count of the corresponding backhaul link at each start or restart.

In this item, sending of one piece of signaling corresponds to one timer. By associating sending of each piece of signaling with to one timer, it is convenient to control transmission time of each signaling.
A3: Start the timer corresponding to the plurality of backhaul links after a first copy of the signaling is sent via the backhaul link and if the timer corresponding to the plurality of backhaul links is not running.

In this item, sending of one piece of signaling corresponds to one timer. A copy of the signaling is the repeatedly transmitted signaling, and in this entry, when another copy other than the first copy of the signaling is sent, a corresponding timer is not started, to control transmission time of the copy of the signaling.

Optionally, in a case that the relay network includes at least two backhaul links, the first hop count or the second hop count is a first hop count or a second hop count corresponding to a first backhaul link. The first backhaul link is one backhaul link that is selected by the remote UE in the relay network and that is used for transmitting signaling.

Alternatively, in a case that the relay network includes at least two backhaul links, the first hop count or the second hop count is a first hop count or a second hop count corresponding to a second backhaul link. The second backhaul link is a backhaul link that is selected by the remote UE in the relay network and that has a maximum first hop count or a maximum second hop count in the at least two backhaul links.

Optionally, the backhaul link in the relay network includes a single-hop relay transmission path or a multi-hop relay transmission path. Optionally, the backhaul link further includes a non-relay transmission path.

Optionally, the timer includes at least one of the following items:
B1: a timer configured to manage a radio link establishment procedure, such as T300;
B2: a timer configured to manage a radio link re-establishment procedure, such as T301;
B3: a timer configured to manage a master cell group (MCG) failure message reporting procedure, such as T316;
B4: a timer configured to manage a procedure in which UE transmits user equipment assistance information (UAI) including a connection release request, such as T346f;
B5: a timer configured to manage a procedure in which a terminal in an RRC connected state performs a system message request through a dedicated message, such as T350;
B6: a timer configured to manage an RRC re-configuration procedure including relay link handover, such as T420; and
B7: a timer configured to manage a radio connection resume procedure, such as T319.

For the item B1, the timer is used for configuring a time range for completing a radio link establishment procedure, is started after the UE sends a radio resource control setup request (RRC Setup Request), and is ended when a response from a peer end is received or the UE determines, due to various reasons, to give up to continue the radio link establishment procedure. When the timer expires, the UE considers that the radio link establishment fails, and resets an MAC layer and notifies related protocol modules.

For the single-hop relay network, an initial value of T300 of an L2 remote UE is configured based on a dedicated parameter t300-RemoteUE of the remote UE.

For the item B2, the timer is used for configuring a time range for completing a radio link re-establishment procedure, is started after the UE sends a radio resource control reestablishment request (RRC Reestablishment Request), and is stopped when a response from a peer end is received or it is determined that a target serving node (such as a target cell or a target relay) is unavailable. After the timer expires, the UE considers that the radio link re-establishment fails, and enters an RRC_IDLE state.

For the single-hop relay network, an initial value of T301 of the L2 remote UE is configured based on a dedicated parameter t301-RemoteUE of the remote UE.

For the item B3, the timer is used for managing a time range for completing a processing procedure of mater cell group (MCG) failure information (MCG Failure Information) reporting. It is started after the MCG Failure Information is sent, and is stopped after a response message is received from a base station. If T316 expires, the radio link re-establishment procedure is initiated.

For the single-hop relay network, an initial value of T319 of the L2 remote UE is configured based on a dedicated parameter t319-RemoteUE of the remote UE.

For the item B4, the timer is used for preventing the UE from frequently sending user equipment assistance information (UAI) including a connection release request (which may alternatively be described as a release preference). It is started after the UE sends the UAI including the connection release request, and stops when receiving a releasePreference configuration (Config) or when a radio link is reestablished or continued.

For the item B5, the timer is used for preventing the UE in an RRC CONNECTED state from frequently initiating a dedicated system information block request (Dedicated SIB Request). T350 is started after the UE sends the system information block request, and during running of T350, a dedicated system information block request is not initiated again. T350 is stopped after the UE receives a requested system information block.

For the item B6, the timer is used for configuring a time range for completing the RRC reconfiguration message (RRCReconfiguration) including relay link handover (sl-PathSwitchConfig), and is started when the remote UE receives the RRC reconfiguration message, and an essential condition for stopping is that a target relay link is successfully established, which is embodied in the existing standard as: stopping when the reconfiguration is completed (for example, an RRC reconfiguration complete message (RRCReconfigurationComplete) is successfully sent via the target relay link). An initial value of the timer is configured in SL-PathSwitchConfig.

Expiry of T420 indicates a sidelink handover failure, and the UE initiates a radio link re-establishment procedure.

For the item B7, the timer is used for managing a time range for completing a radio resource control resume procedure (RRC Resume), is started after the UE sends a radio resource control resume request (RRC Resume Request/RRC ResumeRequest1), and is stopped after the UE receives a corresponding response message. If T319 expires, the UE falls back to the RRC_IDLE state.

The timer in this embodiment of this application may alternatively be another timer, such as a timer configured to manage an MCG failure information reporting procedure. This is not specifically limited in this application.

In this embodiment of this application, the remote UE determines the initial value of the timer based on the initial value configuration parameters related to the backhaul hop count of the backhaul link and the backhaul hop count of the backhaul link in the relay network. In this way, an objective of determining the running duration of the timer based on the backhaul hop count of the backhaul link is achieved, such that the running duration of the timer matches transmission time required by a signaling procedure corresponding to the timer in the relay network. As a result, an unnecessary timer expiration event caused by the remote UE failing to complete corresponding signaling transmission during running of the timer due to improperly configured running duration of the timer can be avoided or reduced, thereby effectively reducing a link interruption count and power consumption of a terminal, and improving wireless connection management performance.

As shown in FIG. 7, an embodiment of this application further provides a timer information processing method, including:

Step 701: A network side device sends initial value configuration parameters of a timer, where initial value configuration parameters are related to a hop count of a backhaul link in a relay network.

The network side device is a network side device in the relay network.

Optionally, the relay network is a multi-hop relay network.

In this embodiment of this application, the initial value configuration parameters may be sent based on a system message or an RRC message. For example, a relay UE within the coverage of a signal of a base station receives the system message including the initial value configuration parameters from the base station, and forwards the system message to a downstream relay UE and a remote UE. After receiving the system message from an upstream relay UE, one relay UE forwards the system message to the downstream relay UE and the remote UE.

In this embodiment of this application, the network side device sends the initial value configuration parameters related to the hop count of the backhaul link in the relay network, and the remote UE determines an initial value of the timer based on the initial value configuration parameters and the backhaul hop count of the backhaul link in the relay network. In this way, an objective of determining the running duration of the timer based on the backhaul hop count of the backhaul link is achieved, such that the running duration of the timer matches transmission time required by a signaling procedure corresponding to the timer in the relay network. As a result, an unnecessary timer expiration event caused by the remote UE failing to complete corresponding signaling transmission during running of the timer due to improperly configured running duration of the timer can be avoided or reduced, thereby effectively reducing a link interruption count and power consumption of a terminal, and improving wireless connection management performance.

Optionally, the initial value configuration parameters include a first initial value. The first initial value is running duration of the timer when a link between the remote UE and the network side device includes one-hop Uu link or includes one-hop Uu link and one-hop PC5 link.

Alternatively, the initial value configuration parameters include an association relationship between the hop count of the backhaul link and a timer initial value.

Optionally, a backhaul hop count of the backhaul link in the association relationship includes at least one of the following:
a first hop count, where the first hop count is the backhaul hop count of the backhaul link in the relay network; and
a second hop count, where the second hop count is a hop count associated with the initial value of the timer.

Optionally, the association relationship includes a correspondence between the hop count of the backhaul link and the timer initial value.

Alternatively, the association relationship includes a correspondence between a hop count range of the backhaul link and the timer initial value.

The association relationship is described in the method embodiment on the remote UE side. Details are not described herein again.

Optionally, the method according to this embodiment of this application further includes:
the network side device sends hop count information, where the hop count information is used by a remote UE to determine a first hop count, and the first hop count is a backhaul hop count of the backhaul link in the relay network.

Herein, the network side device sends the hop count information, and the remote UE determines the second hop count related to the initial value of the timer based on the first hop count, and further determines the initial value of the timer based on the second hop count and the initial value configuration parameters.

In an implementation, that the network side device sends the hop count information includes:
the network side device sends the hop count information through a system message or a Uu radio resource control (RRC) message.

Optionally, in a case that the relay network includes at least two backhaul links, the first hop count or the second hop count is a first hop count or a second hop count corresponding to a first backhaul link. The first backhaul link is one backhaul link that is selected by the remote UE in the relay network and that is used for transmitting signaling.

Alternatively, in a case that the relay network includes at least two backhaul links, the first hop count or the second hop count is a first hop count or a second hop count corresponding to a second backhaul link. The second backhaul link is a backhaul link that is selected by the remote UE in the relay network and that has a maximum first hop count or a maximum second hop count in the at least two backhaul links.

In this embodiment of this application, the network side device sends the initial value configuration parameters related to the hop count of the backhaul link in the relay network, and the remote UE determines an initial value of the timer based on the initial value configuration parameters and the backhaul hop count of the backhaul link in the relay network. In this way, an objective of determining the running duration of the timer based on the backhaul hop count of the backhaul link is achieved, such that the running duration of the timer matches transmission time required by a signaling procedure corresponding to the timer in the relay network. As a result, an unnecessary timer expiration event caused by the remote UE failing to complete corresponding signaling transmission during running of the timer due to improperly configured running duration of the timer can be avoided or reduced, thereby effectively reducing a link interruption count and power consumption of a terminal, and improving wireless connection management performance.

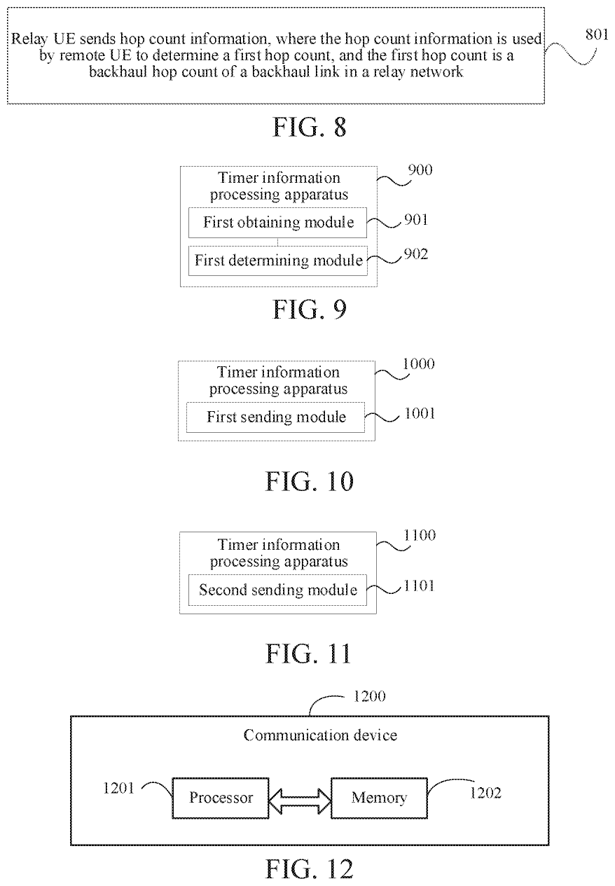

As shown in FIG. 8, an embodiment of this application further provides a timer information processing method, including:

Step 801: Relay UE sends hop count information, where the hop count information is used by a remote UE to determine a first hop count, and the first hop count is a backhaul hop count of a backhaul link in a relay network.

Optionally, the relay UE includes a host relay or an access relay.

Optionally, the hop count information sent by the relay UE indicates hop count information of a backhaul link between a network side device and the relay UE, for example, indicates a total hop count of the backhaul link between the network side device and the relay UE, or indicates a PC5 connection-based hop count of the backhaul link between the network side device and the relay UE.

In an implementation, that the relay UE sends the hop count information includes:
the relay UE sends the hop count information through a system message, a PC5 RRC message, a discovery message, or a proximity services message.

For example, the host relay sends the hop count information through the proximity services message or the PC5 RRC message, or the access relay sends the hop count information through the discovery information, the proximity services message, or the PC5 RRC message.

In this embodiment of this application, the relay UE sends the hop count information. The hop count information is used by the remote UE to determine the first hop count. The first hop count is the backhaul hop count of the backhaul link in the relay network. The remote UE can determine an initial value of a timer based on initial value configuration parameters related to the backhaul hop count of the backhaul link and the backhaul hop count of the backhaul link in the relay network. In this way, an objective of determining the running duration of the timer based on the backhaul hop count of the backhaul link is achieved, such that the running duration of the timer matches transmission time required by a signaling procedure corresponding to the timer in the relay network. As a result, an unnecessary timer expiration event caused by the remote UE failing to complete corresponding signaling transmission during running of the timer due to improperly configured running duration of the timer can be avoided or reduced, thereby effectively reducing a link interruption count and power consumption of a terminal, and improving wireless connection management performance.

The timer information processing method provided in this embodiment of this application may be executed by a timer information processing apparatus. In the embodiments of this application, the timer information processing apparatus provided in the embodiments of this application is described by using an example in which the timer information processing apparatus performs the timer information processing method.

As shown in FIG. 9, an embodiment of this application provides a timer information processing apparatus 900, including:
a first obtaining module 901, configured to obtain initial value configuration parameters of a timer and hop count information, where the hop count information is used for determining a first hop count, the first hop count is a backhaul hop count of a backhaul link in a relay network, and the initial value configuration parameters are related to the backhaul hop count of the backhaul link; and
a first determining module 902, configured to determine an initial value of the timer based on the initial value configuration parameters and the first hop count, where the initial value is used for determining running duration of the timer.

Optionally, the first determining module includes:
a first determining submodule, configured to determine a second hop count based on the first hop count, where the second hop count is a hop count associated with the initial value of the timer; and
a second determining submodule, configured to determine the initial value of the timer based on the second hop count and the initial value configuration parameters.

Optionally, the first determining submodule is configured to perform at least one of the following:
determining the first hop count as the second hop count in a case that the first hop count is a total backhaul hop count of a backhaul link between a remote UE and a network side device in the relay network;
determining the second hop count based on a PC5 connection-based hop count of the backhaul link in a case that the first hop count is the total backhaul hop count of the backhaul link between the remote UE and the network side device in the relay network;
determining the second hop count based on the first hop count and a first adjustment value in a case that the first hop count is the total backhaul hop count of the backhaul link between the remote UE and the network side device in the relay network;
determining the first hop count as the second hop count in a case that the first hop count is the PC5 connection-based backhaul hop count of the backhaul link between the remote UE and the network side device in the relay network;
determining the second hop count based on the first hop count and a second adjustment value in a case that the first hop count is the PC5 connection-based backhaul hop count of the backhaul link between the remote UE and the network side device in the relay network; and
determining the first hop count as the second hop count in a case that the first hop count is equal to the PC5 connection-based backhaul hop count of the backhaul link between the remote UE and the network side device in the relay network minus a third adjustment value.

The first adjustment value, the second adjustment value, and the third adjustment value are all pre-configured integers.

Optionally, the initial value configuration parameters include a first initial value. The first initial value is running duration of the timer when the backhaul link between the remote UE and the network side device includes a one-hop Uu link or includes a one-hop Uu link and a one-hop PC5 link.

Optionally, the second determining submodule includes:
a first determining unit, configured to determine an adjustment value corresponding to the initial value of the timer based on the second hop count and a delay increment corresponding to each hop in the second hop count; and
a second determining unit, configured to determine the initial value of the timer based on the initial value configuration parameters and the adjustment value.

Optionally, the initial value configuration parameters include an association relationship between the hop count of the backhaul link and a timer initial value.

Optionally, the backhaul hop count of the backhaul link in the association relationship includes at least one of the following:
the first hop count; and
the second hop count.

Optionally, the association relationship includes a correspondence between the backhaul hop count of the backhaul link and the timer initial value.

Alternatively, the association relationship includes a correspondence between a hop count range of the backhaul link and the timer initial value.

Optionally, the second determining submodule includes:
an obtaining unit, configured to obtain, based on the association relationship, a timer initial value corresponding to the second hop count; and
a third determining unit, configured to determine the timer initial value corresponding to the second hop count as the initial value of the timer.

Optionally, the apparatus according to this embodiment of this application further includes:
a second determining module, configured to determine, in a case that the first hop count indicates that a PC5 link-based hop count in the relay network is 1, the initial value of the timer based on running duration of the timer in a single-hop relay network.

Optionally, the first obtaining module is configured to obtain the hop count information sent by the network side device or relay UE; or
obtain the hop count information from an SRAP header of a protocol data unit (PDU) of the sidelink relay adaption protocol (SRAP).

Optionally, the first obtaining module is configured to obtain the hop count information through a system message, a Uu radio resource control (RRC) message, a PC5 RRC message, a discovery message, or a proximity services message.

Optionally, the apparatus according to this embodiment of this application further includes:
a processing module, configured to perform a first operation in a case that the remote UE repeatedly transmits, via a plurality of backhaul links, signaling corresponding to the timer.

The first operation includes one of the following items:
separately starting one timer corresponding to the backhaul link after the signaling is sent on each backhaul link, and performing, in a case that the timers corresponding to all the backhaul links expire, an action triggered upon expiry of the timers;
starting a timer corresponding to the plurality of backhaul links after the signaling is sent on each backhaul link and if the timer corresponding to the plurality of backhaul links is not running; restarting the timer corresponding to the plurality of backhaul links if the timer corresponding to the plurality of backhaul link is running, where the initial value of the timer is determined based on a first hop count or a second hop count of a corresponding backhaul link at each start or restart; and
starting the timer corresponding to the plurality of backhaul links after a first copy of the signaling is sent via the backhaul link and if the timer corresponding to the plurality of backhaul links is not running.

Optionally, in a case that the relay network includes at least two backhaul links, the first hop count or the second hop count is a first hop count or a second hop count corresponding to a first backhaul link. The first backhaul link is one backhaul link that is selected by the remote UE in the relay network and that is used for transmitting signaling.

Alternatively, in a case that the relay network includes at least two backhaul links, the first hop count or the second hop count is a first hop count or a second hop count corresponding to a second backhaul link. The second backhaul link is a backhaul link that is selected by the remote UE in the relay network and that has a maximum first hop count or a maximum second hop count in the at least two backhaul links.

Optionally, the timer includes at least one of the following:
a timer configured to manage a radio link establishment procedure;
a timer configured to manage a radio link re-establishment procedure;
a timer configured to manage a master cell group (MCG) failure message reporting procedure;
a timer configured to manage a procedure in which UE sends user equipment assistance information (UAI) including a connection release request;
a timer configured to manage a procedure in which a terminal in an RRC connected state performs a system message request through a dedicated message;
a timer configured to manage an RRC reconfiguration procedure including relay link handover; and
a timer configured to manage a radio connection resume procedure.

In this embodiment of this application, the remote UE determines the initial value of the timer based on the initial value configuration parameters related to the backhaul hop count of the backhaul link and the backhaul hop count of the backhaul link in the relay network. In this way, an objective of determining the running duration of the timer based on the backhaul hop count of the backhaul link is achieved, such that the running duration of the timer matches transmission time required by a signaling procedure corresponding to the timer in the relay network. As a result, an unnecessary timer expiration event caused by the remote UE failing to complete corresponding signaling transmission during running of the timer due to improperly configured running duration of the timer can be avoided or reduced.

As shown in FIG. 10, an embodiment of this application provides a timer information processing apparatus 1000, including:
a first sending module 1001, configured to send initial value configuration parameters of a timer, where the initial value configuration parameters are related to a hop count of a backhaul link in a relay network.

Optionally, the initial value configuration parameters include a first initial value. The first initial value is running duration of the timer when a link between remote UE and a network side device includes a one-hop Uu link or includes a one-hop Uu link and a one-hop PC5 link.

Alternatively, the initial value configuration parameters include an association relationship between the hop count of the backhaul link and a timer initial value.

Optionally, a backhaul hop count of the backhaul link in the association relationship includes at least one of the following:
a first hop count, where the first hop count is the backhaul hop count of the backhaul link in the relay network; and
a second hop count, where the second hop count is a hop count associated with an initial value of the timer.

Optionally, the association relationship includes a correspondence between the hop count of the backhaul link and the timer initial value.

Alternatively, the association relationship includes a correspondence between a hop count range of the backhaul link and the timer initial value.

Optionally, the apparatus according to this embodiment of this application further includes:
a third sending module, configured to send hop count information, where the hop count information is used by the remote UE to determine a first hop count, and the first hop count is the backhaul hop count of the backhaul link in the relay network.

Optionally, the third sending module is configured to send the hop count information through a system message or a Uu radio resource control (RRC) message.

Optionally, in a case that the relay network includes at least two backhaul links, the first hop count or the second hop count is a first hop count or a second hop count corresponding to a first backhaul link. The first backhaul link is one backhaul link that is selected by the remote UE in the relay network and that is used for transmitting signaling.

Alternatively, in a case that the relay network includes at least two backhaul links, the first hop count or the second hop count is a first hop count or a second hop count corresponding to a second backhaul link. The second backhaul link is a backhaul link that is selected by the remote UE in the relay network and that has a maximum first hop count or a maximum second hop count in the at least two backhaul links.

In this embodiment of this application, the network side device sends the initial value configuration parameters related to the hop count of the backhaul link in the relay network, and the remote UE determines an initial value of the timer based on the initial value configuration parameters and the backhaul hop count of the backhaul link in the relay network. In this way, an objective of determining the running duration of the timer based on the backhaul hop count of the backhaul link is achieved, such that the running duration of the timer matches transmission time required by a signaling procedure corresponding to the timer in the relay network. As a result, an unnecessary timer expiration event caused by the remote UE failing to complete corresponding signaling transmission during running of the timer due to improperly configured running duration of the timer can be avoided or reduced, thereby effectively reducing a link interruption count and power consumption of a terminal, and improving wireless connection management performance.

As shown in FIG. 11, an embodiment of this application provides a timer information processing apparatus 1100, including:

a second sending module 1101, configured to send hop count information, where the hop count information is used by a remote UE to determine a first hop count, and the first hop count is a backhaul hop count of a backhaul link in a relay network.

Optionally, the second sending module sends the hop count information through a system message, a PC5 RRC message, a discovery message, or a proximity services message.

In this embodiment of this application, relay UE sends the hop count information. The hop count information is used by the remote UE to determine the first hop count. The first hop count is the backhaul hop count of the backhaul link in the relay network. The remote UE can determine an initial value of a timer based on initial value configuration parameters related to the backhaul hop count of the backhaul link and the backhaul hop count of the backhaul link in the relay network. In this way, an objective of determining the running duration of the timer based on the backhaul hop count of the backhaul link is achieved, such that the running duration of the timer matches transmission time required by a signaling procedure corresponding to the timer in the relay network. As a result, an unnecessary timer expiration event caused by the remote UE failing to complete corresponding signaling transmission during running of the timer due to improperly configured running duration of the timer can be avoided or reduced, thereby effectively reducing a link interruption count and power consumption of a terminal, and improving wireless connection management performance.

The timer information processing apparatus in the embodiments of this application may be an electronic device, such as an electronic device having an operating system, or may be a component, such as an integrated circuit or a chip, in an electronic device. The electronic device may be a terminal, or may be another device other than a terminal. For example, the terminal may include, but is not limited to, the types of terminals listed above, and the another device may be a server, a network attached storage (NAS), or the like. This is not specifically limited in the embodiments of this application.

The timer information processing apparatus provided in the embodiments of this application can implement processes implemented in the method embodiments in FIG. 6 to FIG. 8 and achieve the same technical effects. To avoid repetition, details are not described herein again.

Optionally, as shown in FIG. 12, an embodiment of this application further provides a communication device 1200, including a processor 1201 and a memory 1202. The memory 1202 has a program or instructions runnable on the processor 1201 stored therein. For example, when the communication device 1200 is a terminal, the program or the instructions, when executed by the processor 1201, implement the steps of the foregoing method embodiment performed by the remote UE or the relay UE, and can achieve the same technical effects. When the communication device 1200 is a network side device, the program or the instructions, when executed by the processor 1201, implement the steps of the foregoing method embodiment performed by the network side device, and can achieve the same technical effects. To avoid repetition, details are not described herein again.

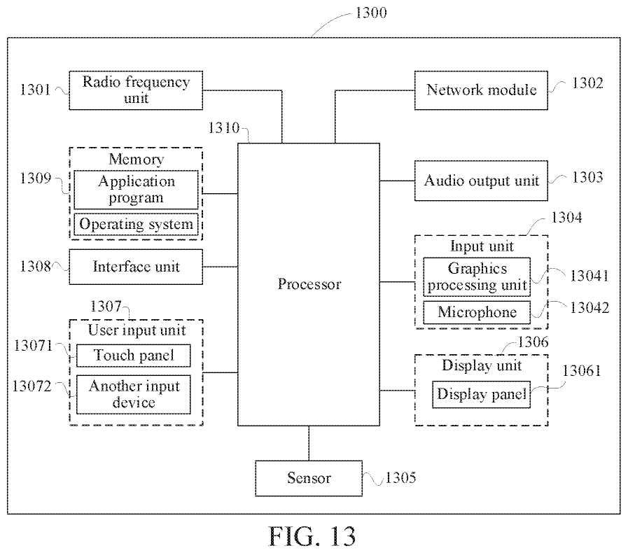

An embodiment of this application further provides a terminal, including a processor and a communication interface. The communication interface is configured to obtain initial value configuration parameters of a timer and hop count information, where the hop count information is used for determining a first hop count, the first hop count is a backhaul hop count of a backhaul link in a relay network, and the initial value configuration parameters are related to the backhaul hop count of the backhaul link. The processor is configured to determine an initial value of the timer based on the initial value configuration parameters and the first hop count, where the initial value is used for determining running duration of the timer. Alternatively, the communication interface is configured to send the hop count information, where the hop count information is used by remote UE to determine the first hop count, and the first hop count is the backhaul hop count of the backhaul link in the relay network. The terminal embodiment corresponds to the foregoing method embodiment on the remote UE side or the relay UE side. Implementation processes and implementations of the foregoing method embodiment are applicable to the terminal embodiment, and can achieve the same technical effects. Specifically, FIG. 13 is a diagram of a hardware structure of a terminal for implementing the embodiments of this application.

A terminal 1300 includes, but is not limited to, at least some components of a radio frequency unit 1301, a network module 1302, an audio output unit 1303, an input unit 1304, a sensor 1305, a display unit 1306, a user input unit 1307, an interface unit 1308, a memory 1309, a processor 1310, and the like.

A person skilled in the art may understand that the terminal 1300 may further include a power supply (such as a battery) for supplying power to the components. The power supply may be logically connected to the processor 1310 through a power management system. In this way, functions, such as charging, discharging, and power consumption management, are implemented through the power management system. The terminal structure shown in FIG. 13 does not constitute a limitation on the terminal. The terminal may include more components or fewer components than those shown in the figure, or some components may be combined, or a different component deployment may be used. Details are not described herein again.

It should be understood that in this embodiment of this application, the input unit 1304 may include a graphics processing unit (GPU) 13041 and a microphone 13042. The graphics processing unit 13041 processes image data of a static picture or an image of a video that is obtained by an image capture apparatus (such as a camera) in a video capture mode or an image capture mode. The display unit 1306 may include a display panel 13061. The display panel 13061 may be configured in the form of a liquid crystal display, an organic light-emitting diode, or the like. The user input unit 1307 includes at least one of a touch panel 13071 and another input device 13072. The touch panel 13071 is also referred to as a touchscreen. The touch panel 13071 may include two parts: a touch detection apparatus and a touch controller. The another input device 13072 may include, but is not limited to, a physical keyboard, a functional key (such as a volume control key or a switch key), a track ball, a mouse, and a joystick. Details are not described herein again.

In this embodiment of this application, after receiving downlink data from a network side device, the radio frequency unit 1301 may transmit the data to the processor 1310 for processing. In addition, the radio frequency unit 1301 may transmit uplink data to the network side device. Typically, the radio frequency unit 1301 includes, but is not limited to, an antenna, an amplifier, a transceiver, a coupler, a low noise amplifier, a duplexer, and the like.

The memory 1309 may be configured to store a software program or instructions and various data. The memory 1309 may mainly include a first storage area storing the program or the instructions and a second storage area storing the data. The first storage area may store an operating system, an application program or instructions required by at least one function (such as a sound playback function or an image display function), and the like. In addition, the memory 1309 may include a volatile memory or a non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM), a static RAM (SRAM), a dynamic RAM (DRAM), a synchronous DRAM (SDRAM), a double data rate SDRAM (DDRSDRAM), an enhanced SDRAM (ESDRAM), a synch link DRAM (SLDRAM), or a direct rambus RAM (DRRAM). In this embodiment of this application, the memory 1309 includes, but is not limited to, these memories and any other suitable type of memory.

The processor 1310 may include one or more processing units. Optionally, the processor 1310 may integrate an application processor and a modem processor, where the application processor mainly processes operations related to an operating system, a user interface, an application program, and the like, and the modem processor mainly processes a wireless communication signal, such as a baseband processor. It may be understood that the modem processor may not be integrated into the processor 1310.

In an embodiment of this application, the radio frequency unit 1301 is configured to obtain initial value configuration parameters of a timer and hop count information, where the hop count information is used for determining a first hop count, the first hop count is a backhaul hop count of a backhaul link in a relay network, and the initial value configuration parameters are related to the backhaul hop count of the backhaul link. The processor 1310 is configured to determine an initial value of the timer based on the initial value configuration parameters and the first hop count, where the initial value is used for determining running duration of the timer.

Optionally, the processor 1310 is configured to:
determine a second hop count based on the first hop count, where the second hop count is a hop count associated with the initial value of the timer; and
determine the initial value of the timer based on the second hop count and the initial value configuration parameters.

Optionally, the processor 1310 is configured to perform at least one of the following:
determining the first hop count as the second hop count in a case that the first hop count is a total backhaul hop count of a backhaul link between remote UE and a network side device in the relay network;
determining the second hop count based on a PC5 connection-based hop count of the backhaul link in a case that the first hop count is the total backhaul hop count of the backhaul link between the remote UE and the network side device in the relay network;
determining the second hop count based on the first hop count and a first adjustment value in a case that the first hop count is the total backhaul hop count of the backhaul link between the remote UE and the network side device in the relay network;
determining the first hop count as the second hop count in a case that the first hop count is the PC5 connection-based backhaul hop count of the backhaul link between the remote UE and the network side device in the relay network;
determining the second hop count based on the first hop count and a second adjustment value in a case that the first hop count is the PC5 connection-based backhaul hop count of the backhaul link between the remote UE and the network side device in the relay network; and
determining the first hop count as the second hop count in a case that the first hop count is equal to the PC5 connection-based backhaul hop count of the backhaul link between the remote UE and the network side device in the relay network minus a third adjustment value.

The first adjustment value, the second adjustment value, and the third adjustment value are all pre-configured integers.

Optionally, the initial value configuration parameters include a first initial value. The first initial value is running duration of the timer when the backhaul link between the remote UE and the network side device includes a one-hop Uu link or includes a one-hop Uu link and a one-hop PC5 link.

Optionally, the processor 1310 is configured to:
determine an adjustment value corresponding to the initial value of the timer based on the second hop count and a delay increment corresponding to each hop in the second hop count; and
determine the initial value of the timer based on the initial value configuration parameters and the adjustment value.

Optionally, the initial value configuration parameters include an association relationship between the hop count of the backhaul link and a timer initial value.

Optionally, the backhaul hop count of the backhaul link in the association relationship includes at least one of the following:
the first hop count; and
the second hop count.

Optionally, the association relationship includes a correspondence between the backhaul hop count of the backhaul link and the timer initial value.

Alternatively, the association relationship includes a correspondence between a hop count range of the backhaul link and the timer initial value.

Optionally, the processor 1310 is configured to:
obtain, based on the association relationship, a timer initial value corresponding to the second hop count; and
determine the timer initial value corresponding to the second hop count as the initial value of the timer.

Optionally, the processor 1310 is configured to:
determine, in a case that the first hop count indicates that a PC5 link-based hop count in the relay network is 1, the initial value of the timer based on configured running duration of the timer in a single-hop relay network.

Optionally, the radio frequency unit 1301 is configured to:
obtain the hop count information sent by the network side device or the relay UE; or
obtain the hop count information from an SRAP header of a protocol data unit (PDU) of the sidelink relay adaption protocol (SRAP).

Optionally, the radio frequency unit 1301 is configured to:
obtain the hop count information through a system message, a Uu radio resource control (RRC) message, a PC5 RRC message, a discovery message, or a proximity services message.

Optionally, the processor 1310 is configured to:
perform a first operation in a case that the remote UE repeatedly transmits, via a plurality of backhaul links, signaling corresponding to the timer.

The first operation includes one of the following:
separately starting one timer corresponding to the backhaul link after the signaling is sent on each backhaul link, and performing, in a case that the timers corresponding to all the backhaul links expire, an action triggered upon expiry of the timers;
starting a timer corresponding to the plurality of backhaul links after the signaling is sent on each backhaul link and if the timer corresponding to the plurality of backhaul links is not running; restarting the timer corresponding to the plurality of backhaul links if the timer corresponding to the plurality of backhaul links is running, where the initial value of the timer is determined based on a first hop count or a second hop count of a corresponding backhaul link at each start or restart; and
starting the timer corresponding to the plurality of backhaul links after a first copy of the signaling is sent via the backhaul link and if the timer corresponding to the plurality of backhaul links is not running.

Optionally, in a case that the relay network includes at least two backhaul links, the first hop count or the second hop count is a first hop count or a second hop count corresponding to a first backhaul link. The first backhaul link is one backhaul link that is selected by the remote UE in the relay network and that is used for transmitting signaling.

Alternatively, in a case that the relay network includes at least two backhaul links, the first hop count or the second hop count is a first hop count or a second hop count corresponding to a second backhaul link. The second backhaul link is a backhaul link that is selected by the remote UE in the relay network and that has a maximum first hop count or a maximum second hop count in the at least two backhaul links.

Optionally, the timer includes at least one of the following:
a timer configured to manage a radio link establishment procedure;
a timer configured to manage a radio link re-establishment procedure;
a timer configured to manage a master cell group (MCG) failure message reporting procedure;
a timer configured to manage a procedure in which UE sends user equipment assistance information (UAI) including a connection release request;
a timer configured to manage a procedure in which a terminal in an RRC connected state performs a system message request through a dedicated message;
a timer configured to manage an RRC reconfiguration procedure including relay link handover; and
a timer configured to manage a radio connection resume procedure.

In this embodiment of this application, the radio frequency unit 1301 is configured to send the hop count information, where the hop count information is used by the remote UE to determine the first hop count, and the first hop count is the backhaul hop count of the backhaul link in the relay network.

Optionally, the radio frequency unit 1301 is configured for
the relay UE to send the hop count information through a system message, a PC5 RRC message, a discovery message, or a proximity services message.

In this embodiment of this application, an objective of determining running duration of the timer based on the backhaul hop count of the backhaul link is achieved, such that the running duration of the timer matches transmission time required by a signaling procedure corresponding to the timer in the relay network. As a result, an unnecessary timer expiration event caused by the remote UE failing to complete corresponding signaling transmission during running of the timer due to improperly configured running duration of the timer can be avoided or reduced.

An embodiment of this application further provides a network side device, including a processor and a communication interface. The communication interface is configured to send initial value configuration parameters of a timer. The initial value configuration parameters are related to a hop count of a backhaul link in a relay network. The network side device embodiment corresponds to the foregoing network side device method embodiment. Implementation processes and implementations of the foregoing method embodiment are applicable to the network side device embodiment, and can achieve the same technical effects.

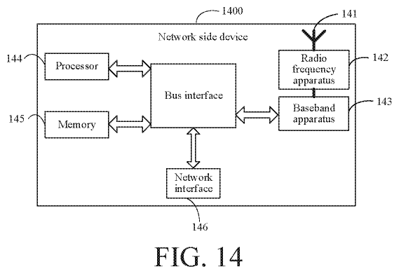

Specifically, an embodiment of this application further provides a network side device. As shown in FIG. 14, a network side device 1400 includes: an antenna 141, a radio frequency apparatus 142, a baseband apparatus 143, a processor 144, and a memory 145. The antenna 141 is connected to the radio frequency apparatus 142. In an uplink direction, the radio frequency apparatus 142 receives information through the antenna 141, and sends the received information to the baseband apparatus 143 for processing. In a downlink direction, the baseband apparatus 143 processes information to be sent and sends the information to the radio frequency apparatus 142. The radio frequency apparatus 142 processes received information and sends the information through the antenna 141.

The method performed by the network side device in the foregoing embodiment may be implemented in the baseband apparatus 143, and the baseband apparatus 143 includes a baseband processor.

The baseband apparatus 143 may include, for example, at least one baseband board. A plurality of chips are disposed on the baseband board. As shown in FIG. 14, one of the chips is, for example, a baseband processor, and is connected to the memory 145 via a bus interface, to invoke a program in the memory 145, so as to perform the network device operations shown in the foregoing method embodiments.

The network side device may further include a network interface 146. The interface is, for example, a common public radio Interface (CPRI).

Specifically, in this embodiment of this application, the network side device 1400 further includes instructions or a program that is stored in the memory 145 and that is runnable on the processor 144. The processor 144 invokes the instructions or the program in the memory 145 to perform the method performed by the modules shown in FIG. 10, and achieves the same technical effect. To avoid repetition, details are not described herein again.

An embodiment of this application further provides a readable storage medium. The readable storage medium has a program or instructions stored therein. The program or the instructions, when executed by a processor, implement processes of the foregoing timer information processing method embodiments, and can achieve the same technical effects. To avoid repetition, details are not described herein again.

The processor is the processor in the terminal in the foregoing embodiment. The readable storage medium includes a computer-readable storage medium, such as a computer read-only memory (ROM), a random-access memory (RAM), a magnetic disk, or an optical disc. In some examples, the readable storage medium may be a non-transitory readable storage medium.

An embodiment of this application further provides a chip. The chip includes a processor and a communication interface. The communication interface is coupled to the processor. The processor is configured to run a program or instructions, to implement processes of the foregoing timer information processing method embodiments, and can achieve the same technical effects. To avoid repetition, details are not described herein again.

It should be understood that the chip mentioned in this embodiment of this application may alternatively be referred to as a system-level chip, a system chip, a chip system, a system on a chip, or the like.

An embodiment of this application further provides a computer program/program product. The computer program/program product is stored in a storage medium. The computer program/program product is executed by at least one processor to implement processes of the timer information processing method embodiments, and can achieve the same technical effects. To avoid repetition, details are not described herein again.

An embodiment of this application further provides a timer information processing system, including: remote UE, relay UE, and a network side device. The remote UE is configured to perform the steps of the method performed by the remote UE described above, the relay UE is configured to perform the steps of the method performed by the relay UE described above, and the network side device is configured to perform the steps of the method performed by the network side device described above.

In the embodiments of this application, the remote UE determines the initial value of the timer based on the initial value configuration parameters related to the backhaul hop count of the backhaul link and the backhaul hop count of the backhaul link in the relay network. In this way, an objective of determining the running duration of the timer based on the backhaul hop count of the backhaul link is achieved, such that the running duration of the timer matches transmission time required by a signaling procedure corresponding to the timer in the relay network. As a result, an unnecessary timer expiration event caused by the remote UE failing to complete corresponding signaling transmission during running of the timer due to improperly configured running duration of the timer can be avoided or reduced.

It should be noted that herein, the terms “include”, “comprise”, or any other variant thereof are intended to cover a non-exclusive inclusion. Therefore, a process, method, item, or apparatus that includes a series of elements not only includes such elements, but also includes other elements not specified expressly, or may include elements inherent to the process, method, item, or apparatus. Unless further limited, an element defined by the phrase “including a/an . . . ” does not exclude the presence of additional identical elements in the process, method, item, or apparatus that includes the element. In addition, it should be noted that, the scope of the method and apparatus in the implementations of this application is not limited to performing functions in an order shown or discussed, and may further include performing functions in a basically simultaneous manner or in a reverse order according to related functions. For example, the described method may be performed in an order different from the described order, and various steps may be added, omitted, or combined. In addition, features described with reference to some examples may be combined in other examples.

Through the description of the foregoing implementations, a person skilled in the art may clearly understand that the method according to the foregoing embodiments may be implemented by using a computer software product and a necessary universal hardware platform, or by using hardware. The computer software product is stored in a storage medium (such as a ROM, a RAM, a magnetic disk, or an optical disc), and includes several instructions for enabling a terminal or a network side device to perform the method described in the embodiments of this application.

The embodiments of this application are described above with reference to the accompanying drawings. However, this application is not limited to the foregoing specific implementations. The foregoing specific implementations are merely exemplary rather than restrictive. A person of ordinary skill in the art may make implementations in many forms under the teaching of this application without departing from the spirit and the scope of protection of the claims of this application, and these implementations all fall within the protection of this application.

What is claimed is:

1. A timer information processing method, comprising:
obtaining, by remote user equipment (UE), initial value configuration parameters of a timer and hop count information, wherein the hop count information is used for determining a first hop count, the first hop count is a backhaul hop count of a backhaul link in a relay network, and the initial value configuration parameters are related to the backhaul hop count of the backhaul link; and
determining, by the remote UE, an initial value of the timer based on the initial value configuration parameters and the first hop count, wherein the initial value is used for determining running duration of the timer.

2. The method according to claim 1, wherein the determining, by the remote UE, an initial value of the timer based on the initial value configuration parameters and the first hop count comprises:
determining, by the remote UE, a second hop count based on the first hop count, wherein the second hop count is a hop count associated with the initial value of the timer; and
determining, by the remote UE, the initial value of the timer based on the second hop count and the initial value configuration parameters.

3. The method according to claim 2, wherein the determining, by the remote UE, a second hop count based on the first hop count comprises at least one of the following:
determining the first hop count as the second hop count in a case that the first hop count is a total backhaul hop count of a backhaul link between the remote UE and a network side device in the relay network;
determining the second hop count based on a PC5 connection-based hop count of the backhaul link in a case that the first hop count is the total backhaul hop count of the backhaul link between the remote UE and the network side device in the relay network;
determining the second hop count based on the first hop count and a first adjustment value in a case that the first hop count is the total backhaul hop count of the backhaul link between the remote UE and the network side device in the relay network;
determining the first hop count as the second hop count in a case that the first hop count is a PC5 connection-based backhaul hop count of the backhaul link between the remote UE and the network side device in the relay network;
determining the second hop count based on the first hop count and a second adjustment value in a case that the first hop count is the PC5 connection-based backhaul hop count of the backhaul link between the remote UE and the network side device in the relay network; or
determining the first hop count as the second hop count in a case that the first hop count is equal to the PC5 connection-based backhaul hop count of the backhaul link between the remote UE and the network side device in the relay network minus a third adjustment value, wherein
the first adjustment value, the second adjustment value, and the third adjustment value are all pre-configured integers.

4. The method according to claim 2, wherein the initial value configuration parameters comprise a first initial value, and the first initial value is running duration of the timer when the backhaul link between the remote UE and a network side device comprises a one-hop Uu link or comprises a one-hop Uu link and a one-hop PC5 link.

5. The method according to claim 4, wherein the determining, by the remote UE, the initial value of the timer based on the second hop count and the initial value configuration parameters comprises:
determining an adjustment value corresponding to the initial value of the timer based on the second hop count and a delay increment corresponding to each hop in the second hop count; and
determining the initial value of the timer based on the initial value configuration parameters and the adjustment value.

6. The method according to claim 2, wherein the initial value configuration parameters comprise an association relationship between a hop count of the backhaul link and a timer initial value.

7. The method according to claim 6, wherein the backhaul hop count of the backhaul link in the association relationship comprises at least one of the following:
the first hop count; or
the second hop count.

8. The method according to claim 1, wherein the timer comprises at least one of the following:
a timer configured to manage a radio link establishment procedure;
a timer configured to manage a radio link re-establishment procedure;
a timer configured to manage a master cell group (MCG) failure message reporting procedure;
a timer configured to manage a procedure in which a terminal sends user equipment assistance information (UAI) comprising a connection release request;
a timer configured to manage a procedure in which a terminal in a radio resource control (RRC) connected state performs a system message request through a dedicated message;
a timer configured to manage an RRC reconfiguration procedure comprising relay link handover; or
a timer configured to manage a radio connection resume procedure.

9. A non-transitory readable storage medium, wherein the readable storage medium stores a program or instructions, and the program or the instructions, when executed by a processor, implement steps of the timer information processing method according to claim 1.

10. A timer information processing method, comprising:
sending, by a network side device, initial value configuration parameters of a timer, wherein the initial value configuration parameters are related to a hop count of a backhaul link in a relay network.

11. The method according to claim 10, wherein the initial value configuration parameters comprise a first initial value, and the first initial value is a running duration of the timer when a link between remote user equipment (UE) and the network side device comprises a one-hop Uu link or comprises a one-hop Uu link and a one-hop PC5 link; or
the initial value configuration parameters comprise an association relationship between the hop count of the backhaul link and a timer initial value.

12. The method according to claim 11, wherein a backhaul hop count of the backhaul link in the association relationship comprises at least one of the following:
a first hop count, wherein the first hop count is the backhaul hop count of the backhaul link in the relay network; or
a second hop count, wherein the second hop count is a hop count associated with an initial value of the timer.

13. The method according to claim 10, further comprising:
sending, by the network side device, hop count information, wherein the hop count information is used by a remote user equipment (UE) to determine the first hop count, and the first hop count is the backhaul hop count of the backhaul link in the relay network.

14. A network side device, comprising a processor and a memory, wherein the memory stores a program or instructions runnable on the processor, and the program or the instructions, when executed by the processor, implement steps of the timer information processing method according to claim 10.

15. A non-transitory readable storage medium, wherein the readable storage medium stores a program or instructions, and the program or the instructions, when executed by a processor, implement steps of the timer information processing method according to claim 10.

16. A terminal, comprising: a processor and a memory, wherein the memory stores a program or instructions runnable on the processor, and the program or the instructions, when executed by the processor, implement steps of:
obtaining initial value configuration parameters of a timer and hop count information, wherein the hop count information is used for determining a first hop count, the first hop count is a backhaul hop count of a backhaul link in a relay network, and the initial value configuration parameters are related to the backhaul hop count of the backhaul link; and
determining an initial value of the timer based on the initial value configuration parameters and the first hop count, wherein the initial value is used for determining running duration of the timer.

17. The terminal according to claim 16, wherein the processor is further configured to:
determine a second hop count based on the first hop count, wherein the second hop count is a hop count associated with the initial value of the timer; and
determine the initial value of the timer based on the second hop count and the initial value configuration parameters.

18. The terminal according to claim 17, wherein the processor is further configured to perform at least one of the following:
determining the first hop count as the second hop count in a case that the first hop count is a total backhaul hop count of a backhaul link between remote user equipment (UE) and a network side device in the relay network;
determining the second hop count based on a PC5 connection-based hop count of the backhaul link in a case that the first hop count is the total backhaul hop count of the backhaul link between the remote UE and the network side device in the relay network;
determining the second hop count based on the first hop count and a first adjustment value in a case that the first hop count is the total backhaul hop count of the backhaul link between the remote UE and the network side device in the relay network;
determining the first hop count as the second hop count in a case that the first hop count is a PC5 connection-based backhaul hop count of the backhaul link between the remote UE and the network side device in the relay network;
determining the second hop count based on the first hop count and a second adjustment value in a case that the first hop count is the PC5 connection-based backhaul hop count of the backhaul link between the remote UE and the network side device in the relay network; or
determining the first hop count as the second hop count in a case that the first hop count is equal to the PC5 connection-based backhaul hop count of the backhaul link between the remote UE and the network side device in the relay network minus a third adjustment value, wherein
the first adjustment value, the second adjustment value, and the third adjustment value are all pre-configured integers.

19. The terminal according to claim 17, wherein the initial value configuration parameters comprise a first initial value, and the first initial value is running duration of the timer when the backhaul link between a remote user equipment (UE) and the network side device comprises a one-hop Uu link or comprises a one-hop Uu link and a one-hop PC5 link.

20. The terminal according to claim 16, wherein the timer comprises at least one of the following:
a timer configured to manage a radio link establishment procedure;
a timer configured to manage a radio link re-establishment procedure;
a timer configured to manage a master cell group (MCG) failure message reporting procedure;
a timer configured to manage a procedure in which a terminal sends user equipment assistance information (UAI) comprising a connection release request;
a timer configured to manage a procedure in which a terminal in an RRC connected state performs a system message request through a dedicated message;
a timer configured to manage an radio resource control (RRC) reconfiguration procedure comprising relay link handover; or
a timer configured to manage a radio connection resume procedure.
